(19) United States
(12) Patent Application Publication
(10) Pub. No.: US 2005/0159979 A1
(43) Pub. Date: Jul. 21, 2005

(54) Systems and methods for succinctly presenting clinical trial information

(75) Inventor: Dane J. Dickson, Rexburg, ID (US)

Correspondence Address: THORPE NORTH & WESTERN, LLP., 8180 SOUTH 700 EAST, SUITE 200, P.O. BOX 1219, SANDY, UT, 84070, US

(73) Assignee: Summarius Corporation

(21) Appl. No.: 10/763,066

(22) Filed: Jan. 21, 2004

(51) Int. Cl. G06F 17/60

(52) U.S. Cl. 705/2

(57) ABSTRACT

A presentation system for succinctly presenting information contained in a clinical trial report can include a summary report, having information displayed thereon in a plurality of spatially distinct, predefined regions. Each of the predefined regions has an information type associated therewith. The plurality of spatially distinct, predefined regions include: a bibliographical region, including bibliographical information relating to the clinical trial report; a patient characteristic region, including patient characteristic information relating to patients treated in a clinic trial reported in the clinical trial report; an end point region, including end point information relating to at least one end point of the clinical trial; and an arm region, including arm information relating to at least one arm of the clinical trial.

### FIELD OF THE INVENTION

The present invention relates generally to condensing and succinctly presenting clinical trial information originally contained in detailed clinical trial reports.

### BACKGROUND OF THE INVENTION

Doctors, pharmacists, and other health care professionals often depend on clinical trial reports to obtain information relating to newly developed treatments and drugs. Clinical trials are generally recognized as the most effective manner to evaluate new treatment regimens and drugs. Because of the importance of clinical trials, they are generally very carefully planned, executed, and documented. As a result, documentation reporting on the methods and findings of the trials generally contains a very detailed description of each step of the trial, including selection of the methods used, goals (or “end points”) of the trial, patient characteristics, findings, etc.

As a result of the care taken in documenting the clinical trial, clinical trial reports are often very lengthy documents that require a great deal of time to read and analyze. As medical practitioners often have limited time, the complexity of clinical trial reports can tend to impede the ability of many practitioners to keep abreast of recent developments. By failing to keep abreast of recent developments, practitioners can not be capable of providing the best quality of care to their patients or customers.

To further exacerbate the problems practitioners have in finding sufficient time to keep abreast of current developments, practitioners must generally monitor several different areas of medical research to maintain a level of knowledge sufficient to maintain proficiency in treating or counseling patients. Thus, not only are practitioners pressured to keep abreast of new developments in their own specialized areas of practice, they must often also monitor areas of practice that can overlap with their specialty.

While much information is available to practitioners concerning recent treatments and drugs, many practitioners do not have, or do not make, sufficient time to process all of the information published in clinical trial reports.

### SUMMARY OF THE INVENTION

It has been recognized that it would be advantageous to develop a system for succinctly presenting information contained in detailed clinical trial reports in a manner that can be easily and quickly read and understood by medical practitioners.

The invention provides a presentation system for consistently and succinctly presenting information contained in multiple clinical trial reports, and includes a collection of individual summary reports. Each individual summary report of the collection can be associated with a clinical trial report of the multiple clinical trial reports; can be organized using a template common to other of the individual summary reports; and can have information displayed thereon in a plurality of spatially distinct, predefined regions. Each of the predefined regions can have an information type associated therewith. The plurality of spatially distinct, predefined regions can include: a bibliographical region, including bibliographical information relating to the clinical trial report; a patient characteristic region, including patient characteristic information relating to patients treated in a clinical trial reported in the clinical trial report; an end point region, including end point information relating to at least one end point of the clinical trial; and an arm region, including arm information relating to at least one arm of the clinical trial.

In accordance with another aspect of the present invention, a method of consistently and succinctly presenting information from multiple clinical trial reports is provided. The method can include the step of generating a collection of individual summary reports each associated with a clinical trial report of the multiple clinical trial reports. Each of the individual summary reports can have a template common to other of the individual summary reports. Each of the individual summary reports can be prepared by: displaying bibliographical information relating to the clinical trial report in a spatially distinct, predefined bibliography region; displaying patient characteristic information relating to patients treated in a clinical trial reported in the clinical trial report in a spatially distinct, predefined patient characteristic region; displaying end point information relating to end points of the clinical trial in a spatially distinct, predefined end point region; and displaying arm information relating to at least one arm of the clinical trial in a spatially distinct, predefined arm region.

In accordance with another aspect of the invention, a method for distilling and succinctly and consistently presenting information from multiple clinical trial reports is provided. The method can include the steps of: generating a collection of individual summary reports each associated with a clinical trial report of the multiple clinical trial reports, each of the individual summary reports having a template common to other of the individual summary reports; and culling from the multiple clinical trial reports information relating to each of a group of information types. The method can include a further step of preparing each of the individual summary reports by: displaying bibliographical information relating to the clinical trial report in a spatially distinct, predefined bibliography region; displaying patient characteristic information relating to patients treated in a clinical trial reported in the clinical trial report in a spatially distinct, predefined patient characteristic region; displaying end point information relating to end points of the clinical trial in a spatially distinct, predefined end point region; and displaying arm information relating to at least one arm of the clinical trial in a spatially distinct, predefined arm region.

In accordance with another aspect of the invention, a presentation system for succinctly presenting information contained in a clinical trial report is provided. The system can include a summary report, having information displayed thereon in a plurality of spatially distinct, predefined regions. Each of the predefined regions can have an information type associated therewith. The plurality of spatially distinct, predefined regions can include: a bibliographical region, including bibliographical information relating to the clinical trial report; a patient characteristic region, including patient characteristic information relating to patients treated in a clinic trial reported in the clinical trial report; an end point region, including end point information relating to at least one end point of the clinical trial; an arm region, including arm information relating to at least one arm of the clinical trial; and a regimen region, including graphically presented regimen information relating to at least one arm of the clinical trial.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic view of a presentation system in accordance with an exemplary embodiment of the present invention;

FIG. 2 is a schematic diagram of a computer monitor display and related computer apparatus in accordance with an exemplary embodiment of the present invention; and

FIG. 3 is a schematic view of a representative regimen graphic detailing an exemplary layout of a clinical trial.

### DETAILED DESCRIPTION OF THE PREFERRED EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art, and having possession of this disclosure, are to be considered within the scope of the invention.

As used herein, the term “clinical trial report” is to be understood to include reports of clinical trials of a variety of types, including, without limitation, medical journal articles, drug and clinical trial abstracts, media releases, etc. In the case where a single clinical trial is referenced, it is to be understood that the present invention can readily be adapted to present information from a single trial report. Alternatively, information relating to multiple trial reports can also be displayed in accordance with embodiments of the present invention.

As used herein, the term “spatially distinct regions” is to be understood to mean regions which are non-inclusive of other regions, e.g., regions that do not spatially or physically overlap one another.

As used herein, the term “arm” is to be understood to mean one or more groups into which patients are divided in a clinical trial. While not so limited, each arm of a clinical trial can include patients which are given the same treatment as other patients in the arm. Further, patients of a particular arm typically receive treatment that is different from treatment received by patients in another arm. The present system can present information related to one or more arms of a clinical trial.

As used herein, the term “common template,” or when referring to a “template common” as being common to other reports, it is to be understood that a common format is used for multiple summary reports of a collection. In other words, similar fields or areas of information are displayed in similar locations relative from one summary report to the next. For example, two summary reports having a common template can include similar information fields, such as arm information fields, which are displayed on the reports in substantially the same location on each report. Thus, a reader of the summary reports would look to the same location on each summary report for information specific to each report, even though the individual reports have different data. In other words, it is to be understood that while two reports may share a common template with similar information types displayed in similar areas, the same information may not be displayed in each information type area, as the reports likely relate to two separate clinical trial reports reporting differing information.

As used herein, the term “viewable” when referring to a display, such as a substrate or computer display, is to be understood to mean that the display viewable by humans. Viewable pages of paper, for example, can include paper sizes of “letter,” “legal,” “executive,” “A4,” “A5,” etc., as well as non-conventional page sizes.

When referring to “paper,” any paper substrate can be used, including plain papers, fibrous papers, coated papers, etc.

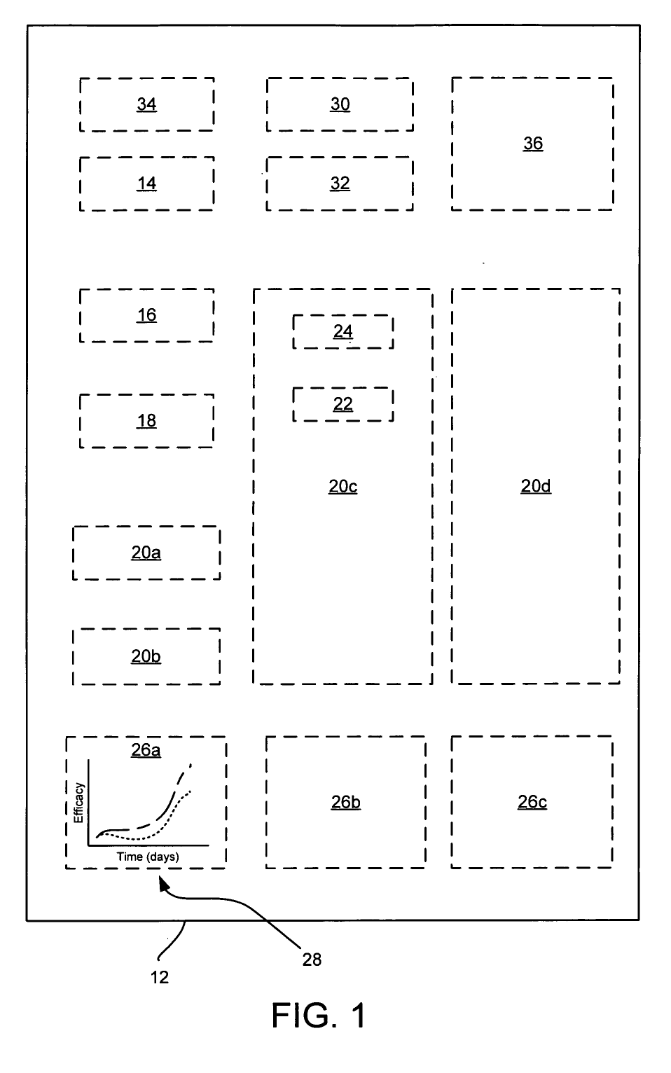

With the above definitions in mind, illustrated schematically in FIG. 1 is a system in accordance with an embodiment of the present invention for succinctly presenting information contained in one or more clinical trial reports. The system can include an individual summary report 12 on which information can be displayed in a plurality of spatially distinct, predefined regions 14, 16, 18, etc. The individual summary report can be displayed on a variety of display media, and in this particular example, the display is a media substrate, such as paper or an overhead projector sheet. The type of information displayable on the display can be of a variety of types, but is generally of specific types of information contained in detailed textual documents, such as clinical trial reports.

The specific types of information can each be exclusively displayed in a spatially distinct, predefined region associated with each specific type of information. The spatially distinct, predefined regions can include, without limitation, a bibliographical region 14, which can include bibliographical information relating to the clinical trial report. Bibliographical information can include, without limitation, a title of the clinical trial report, a publication in which the report was published, authors of the report, researchers conducting the trial, a standard citation, etc. A patient characteristic region 16 can also be present and can include patient characteristic information relating to patients treated in the clinical trial. Patient characteristic information can include, without limitation, age groups, health conditions, symptoms, etc. Another predefined region can be an end point region 18 including end point information relating to at least one end point of the clinical trial. End point information can include, without limitation, goals and/or objectives of the clinical trial, or a question or questions addressed by the clinical trial.

An arm region(s) 20a, 20b, 20c, 20d can also be presented in spatially distinct, predefined regions. An arm region(s) can include arm information relating to at least one arm of the clinical trial. The arm region or regions can include arm information of a variety of types. For example, in FIG. 1, arm region 20a can be an arm comparison region, which can include information comparing each of the arms of the clinical trial to one another. This arm comparison region can include a brief summary of the one or more arms of the clinical trial as the arms relate to one another. For example, the arm comparison information can indicate the drugs or dosages given to patients of one arm as compared to drugs or dosages of another arm. In the case where the clinical trial involves only one arm, the arm comparison information can address, for example, the “control” arm, e.g., the placebo arm or the arm in which standard treatment is given.

In addition to the type of arm information discussed above, arm information can also include arm stratification information, which can be contained, for example, in arm region 20b. This arm stratification region can include information relating to stratification of the patients in the clinical trial. For example, the arm stratification information can include information indicating that the patients were stratified based on such traits as their countries of origin, age, weight, prior medical conditions or treatments, etc.

Arm information can also include arm-specific information, which can be contained, for example, in arm regions 20c and 20d. This arm-specific information can relate to at least one arm of the clinical trial and can be presented to summarize the details of each arm. Arm-specific information can include, without limitation, dosages delivered to patients of the particular arm, dosage delivery rates to those patients, etc. The type of arm-specific information will typically vary according to the type of clinical trial that is being summarized in the display. Each spatially distinct, predefined region can include a title 24, shown by example in arm region 20c. The title can be uniquely associated with the information type associated with and displayed in the spatially distinct region. For example, the title can read “Arm 1—Drug Type I,” with Drug Type I being one of the drugs administered in the clinical trial. Any number of arm-specific regions 20c, 20d, etc. can be included in the system, as dictated by the number of arms in the clinical trial.

In one aspect of the invention, at least one of the spatially distinct arm regions of the display can also include an administration region 22, shown for example in arm region 20c, which can contain information relating to administration of treatment during the clinical trial. This summarized information can include information on the drugs delivered to the patients, the manner of administration of the drugs, administration frequency, etc.

At least one of the arm regions that include arm-specific information, for example arm-specific region 20c or 20d, can have a distinct, visibly identifiable color associated therewith. The visibly identifiable color can be distinct from visibly identifiable colors associated with other arm-specific arm regions. For example, in the case where arm-specific region 20c includes a title 24 uniquely associated therewith, the title can be presented in the visibly distinct color. In this manner, information related to the arm which is associated with arm-specific region 20c can be presented throughout the display in the same color. For example, if the trial involved two arms, one arm can be represented by yellow and the other by red. In each region in which information from each of the two arms is presented, each arm can be consistently represented by yellow or red, whichever color is associated with the arm-specific region.

The system can further include a results summary region, shown generally at 26a, 26b, or 26c, which can contain summary information of the results of the clinical trial. The results summary information can include information relating to how the various arms performed in the clinical trial. The results summary region can contain primarily textual information, or can include graphically displayed information. For example, region 26a can include a graph 28 which compares efficacy values over time. While not so limited, each arm can be represented in the graphical display in a different line type, e.g., dotted versus dashed, and/or can be represented in the graphical display in the distinct color associated with the arm. This feature adds a further benefit in that graphical representations are often more readily understood when presenting particular data. A textual results region 26c can also be included which can discuss in textual context the contents of the graphical representation of the graphic 28 of region 26a. Additionally, results region(s) 26b and/or 26c can also include either a textual or graphical format, or a combination of the two.

It is to be understood that each of the various distinct regions can present information in a textual or graphical format, or a format that combines textual and graphical information. Also, while each of the various spatially distinct regions are shown and discussed having a particular location on the display 12, it is to be understood that the spatially distinct regions can be disposed on the display in a variety of locations. For example, the arm-specific regions 20c, 20d can be located to the left or right or upper or lower portion of the display. Similarly, the spatially distinct regions are shown in the figures having exemplary geometric shapes and sizes. However, the spatially distinct regions can assume a variety of shapes and sizes, and need not be clearly delineated by a border or other marking. That is, the regions can simply contain textual or graphical information without markings delineating the regions from other regions.

The summary report 12 of the present invention can be displayed on a variety of display types known in the art. The display can be, for example, a substrate or an electronic display device. Examples of suitable substrates include paper, overhead projector transparencies, poster board, or the like. In one aspect of the invention, the substrate is paper and includes not more than two viewable pages of paper. The two viewable pages can be disposed on opposing sides of a single sheet of paper, e.g., the two viewable pages can be printed on two sides of a single sheet of paper. In another aspect of the invention, the display comprises a single viewable page of paper. The present invention can thus advantageously display all, or nearly all, salient information contained in a clinical trial report on an easily read and understood display that can be as few as one or two sheets of paper. This can greatly benefit medical practitioners who can obtain the necessary information from a clinical trial by reading or viewing only one or a few pages of information.

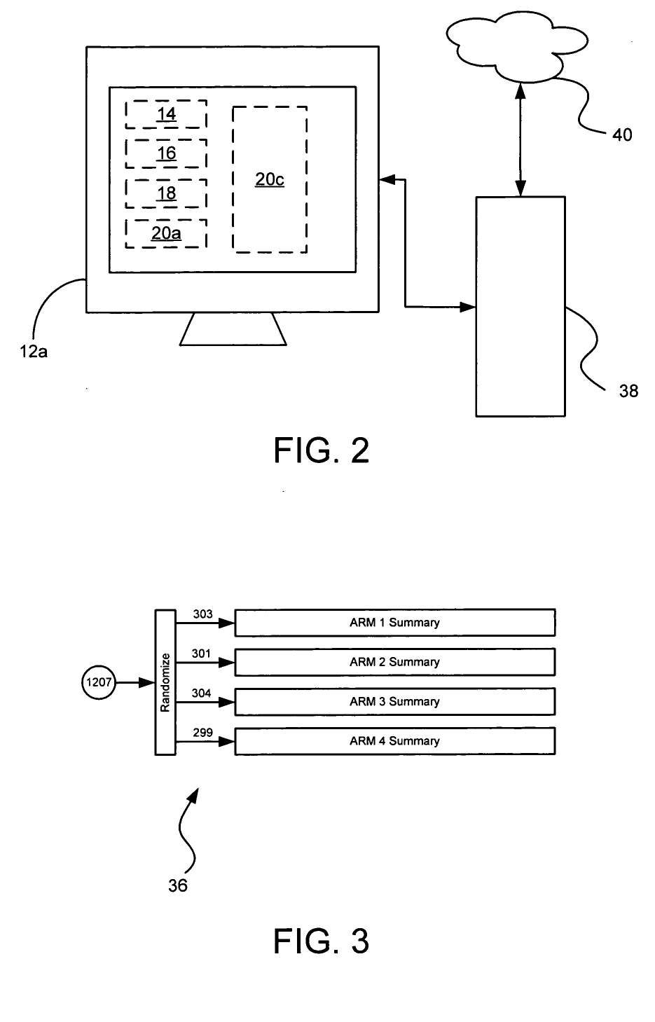

In addition to displaying the summary report 12 on a media or other substrate, the summary report of the present invention can be displayed on an electronic display. Examples of suitable electronic displays include computer monitors, projectors, or the like. As illustrated in FIG. 2, the summary report 12a can be displayed on a computer monitor on which various regions, such as regions 14, 16, 18, 20a, 20c, as described in detail above, can be disposed. The computer monitor display can be operatively coupled to a computer 38 on or in which digital files can be stored that contain the information to be displayed by the present system. The computer can also be operatively coupled to an outside data source, such as internet 40.

In this aspect, summary report 12a of the present invention can be stored in digital files in a local or remote storage device and can be retrieved and displayed via a local computer monitor. This embodiment can be advantageous in that a central database of drug trial report summaries in accordance with the present system can be accessed by practitioners in either a local or a remote application. For example, a central server or web site can be established to which practitioners pay a fee to access and/or to establish an account. Once an account has been established, the practitioner can access the web site and view a variety of summary reports relating to a variety of published drug trial reports.

Returning to FIG. 1, the spatially distinct regions can be established for a number of differing types of information. Examples of other spatially distinct regions include, without limitation, a study-type summary region 30 that can include information related to the phase of the trial, e.g., phase I, II, III or IV, as those phases are known by those skilled in the art. The study-type region can also include information on randomization in the trial, whether the trial was multi-institutional, whether a placebo was used, etc.

Other examples of spatially distinct regions include a trial summary region 32 which can include a brief summary of the results of the trial, e.g., whether the trial had a dispositive outcome, etc. A spatially distinct, predefined medical category region 34 can include medical category information therein. The medical category information can indicate general fields to which the trial can be relevant, e.g., oncology, cardiology, etc. Also, a regimen region 36 can be included and can include information relating to the regimen(s) of the trial.

Shown schematically by example in FIG. 3, the regimen information can be in the form of a graphic that includes a summary of the total number of patients (e.g., 1207), the manner in which the patients were divided into arms (e.g., randomly), the number of patients in each arm (e.g., 303, 301, 304 and 299), and a brief summary of the characteristics of each arm (e.g., ARM 1 Summary, ARM 2 Summary, ARM 3 Summary and ARM 4 Summary). The arms shown in FIG. 3 can include a visibly distinct color associated with each arm, further simplifying identification of arm information.

As described, the system can advantageously be used to distill and succinctly present information contained in multiple clinical trial reports. Clinical trial reports often contain a great deal of detailed information reporting on all, or nearly all, aspects of the clinical trial. As such, clinical trial reports are often five to ten pages of dense and technical data presented in a textual or graphical format that requires substantial time for a medical practitioner to read and understand. The present invention can succinctly present highly relevant portions of the clinical trial report in a manner that can be easily and quickly read and understood by a practitioner, saving the practitioner significant time in keeping abreast of recent developments.

As the present invention can be standardized into a readily recognizable template, the present invention can be applied to clinical trials of a wide variety of drugs and techniques in a wide variety of practice areas. In this manner, a practitioner who can specialize in a particular field of medicine can easily obtain information from a differing field, even in the case where the practitioner can be unfamiliar with the differing field. Thus, the present invention provides a templated, easily understood presentation system that can standardize the presentation of information from a variety of medical endeavors.

The present invention also provides a method of consistently and succinctly presenting information from multiple clinical trial reports. The method can include the step of generating a collection of individual summary reports each associated with a clinical trial report of the multiple clinical trial reports. Each of the individual summary reports can have a template common to other of the individual summary reports. Each of the individual summary reports can be prepared by: displaying bibliographical information relating to the clinical trial report in a spatially distinct, predefined bibliography region; displaying patient characteristic information relating to patients treated in a clinical trial reported in the clinical trial report in a spatially distinct, predefined patient characteristic region; displaying end point information relating to end points of the clinical trial in a spatially distinct, predefined end point region; and displaying arm information relating to at least one arm of the clinical trial in a spatially distinct, predefined arm region.

The present invention also provides a method for distilling and succinctly and consistently presenting information from multiple clinical trial reports. The method can include the steps of: generating a collection of individual summary reports each associated with a clinical trial report of the multiple clinical trial reports, each of the individual summary reports having a template common to other of the individual summary reports; and culling from the multiple clinical trial reports information relating to each of a group of information types. The method can include the further step of preparing each of the individual summary reports by: displaying bibliographical information relating to the clinical trial report in a spatially distinct, predefined bibliography region; displaying patient characteristic information relating to patients treated in a clinical trial reported in the clinical trial report in a spatially distinct, predefined patient characteristic region; displaying end point information relating to end points of the clinical trial in a spatially distinct, predefined end point region; and displaying arm information relating to at least one arm of the clinical trial in a spatially distinct, predefined arm region.

Culling, or otherwise identifying and categorizing, information from the clinical trial report can be carried out in a number of ways. In one aspect, the clinical trial report is read by a knowledgeable individual who identifies portions of the generally textual trial report and groups the information into predetermined groups. It is also contemplated that the culling and/or presenting process can be automated with the use of hardware and software capable of scanning and collecting appropriate information to categorize the information in groups from clinical trial reports. In addition, a combination of human and computer processing can be utilized to optimize culling and presenting information from the clinical trial report.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A presentation system for consistently and succinctly presenting information contained in multiple clinical trial reports, comprising a collection of individual summary reports, each individual summary report of the collection:
a) being associated with a clinical trial report of the multiple clinical trial reports;
b) being organized using a template common to other of the individual summary reports; and
c) having information displayed thereon in a plurality of spatially distinct, predefined regions, each of the predefined regions having an information type associated therewith, the plurality of spatially distinct, predefined regions including:
i) a bibliographical region, including bibliographical information relating to the clinical trial report;
ii) a patient characteristic region, including patient characteristic information relating to patients treated in a clinical trial reported in the clinical trial report;
iii) an end point region, including end point information relating to at least one end point of the clinical trial; and
iv) an arm region, including arm information relating to at least one arm of the clinical trial.

2. The system of claim 1, wherein each spatially distinct, predefined region further includes a title uniquely associated with the information type associated with and displayed in the spatially distinct region.

3. The system of claim 1, wherein each individual summary report is displayed on a display comprising a member selected from the group consisting of a substrate and an electronic display device.

4. The system of claim 3, wherein the substrate comprises paper.

5. The system of claim 4, wherein the display comprises not more than two viewable pages of paper.

6. The system of claim 5, wherein the not more than two viewable pages of paper are disposed on opposing sides of a single sheet of paper.

7. The system of claim 4, wherein the display comprises a single viewable page of paper.

8. The system of claim 3, wherein the display comprises a computer monitor.

9. The system of claim 1, wherein the arm region includes information of a type selected from the group consisting of arm comparison information comparing each arm of the clinical trial; arm stratification information relating to stratification of the patients of the clinical trial; and arm-specific information relating to at least one arm of the clinical trial.

10. The system of claim 9, wherein the arm region having arm-specific information included therein has a visibly identifiable color associated therewith, the visibly identifiable color being distinct from visibly identifiable colors associated with other arm-specific arm regions of the individual summary report.

11. The system of claim 1, wherein at least one spatially distinct arm region of the individual summary report further includes an administration region containing information relating to administration of treatment during the clinical trial.

12. The system of claim 1, wherein the information displayed in at least one of the spatially distinct, predefined regions includes graphically-presented information.

13. The system of claim 1, wherein the individual summary report further includes a spatially distinct, predefined medical category region having medical category information contained therein.

14. A method of consistently and succinctly presenting information from multiple clinical trial reports, comprising the step of generating a collection of individual summary reports each associated with a clinical trial report of the multiple clinical trial reports, each of the individual summary reports having a template common to other of the individual summary reports, and each of the individual summary reports being prepared by:
a) displaying bibliographical information relating to the clinical trial report in a spatially distinct, predefined bibliography region;
b) displaying patient characteristic information relating to patients treated in a clinical trial reported in the clinical trial report in a spatially distinct, predefined patient characteristic region;
c) displaying end point information relating to end points of the clinical trial in a spatially distinct, predefined end point region; and
d) displaying arm information relating to at least one arm of the clinical trial in a spatially distinct, predefined arm region.

15. The method of claim 14, comprising the further step of displaying a title within each spatially distinct, predefined region, said title being uniquely associated with an information type associated with and displayed in the spatially distinct region.

16. The method of claim 14, wherein each individual summary report is displayed on a display comprising a display selected from the group consisting of a substrate and an electronic display device.

17. The method of claim 16, wherein the substrate comprises paper.

18. The method of claim 17, wherein the display comprises not more than two viewable pages of paper.

19. The method of claim 18, wherein the not more than two viewable pages of paper are disposed on opposing sides of a single sheet of paper.

20. The method of claim 17, wherein the display comprises a single viewable page of paper.

21. The method of claim 16, wherein the display comprises a computer monitor.

22. The method of claim 14, wherein the arm region includes information of a type selected from the group consisting of arm comparison information comparing each arm of the clinical trial; arm stratification information relating to stratification of the patients of the clinical trial; and arm-specific information relating to at least one arm of the clinical trial.

23. The method of claim 22, comprising the further step of associating a visibly identifiable color with the arm region containing the arm-specific information, said visibly identifiable color being distinct from visibly identifiable colors associated with other arm-specific arm regions of the individual summary report.

24. The method of claim 14, comprising the further step of graphically displaying information in at least one of the spatially distinct, predefined regions.

25. The method of claim 14, wherein at least one spatially distinct arm region of the display further includes an administration region containing information relating to administration of treatment during the clinical trial.

26. A method for distilling and succinctly and consistently presenting information from multiple clinical trial reports, comprising the steps of:
a) generating a collection of individual summary reports each associated with a clinical trial report of the multiple clinical trial reports, each of the individual summary reports having a template common to other of the individual summary reports;
b) culling from the multiple clinical trial reports information relating to each of a group of information types;
c) preparing each of the individual summary reports by:
i) displaying bibliographical information relating to the clinical trial report in a spatially distinct, predefined bibliography region;
ii) displaying patient characteristic information relating to patients treated in a clinical trial reported in the clinical trial report in a spatially distinct, predefined patient characteristic region;
iii) displaying end point information relating to end points of the clinical trial in a spatially distinct, predefined end point region; and
iv) displaying arm information relating to at least one arm of the clinical trial in a spatially distinct, predefined arm region.

27. The method of claim 26, comprising the further step of displaying a title within each spatially distinct, predefined region, said title being uniquely associated with an information type associated with and displayed in the spatially distinct region.

28. The method of claim 26, wherein each of the individual summary reports are displayed on a display comprising a display selected from the group consisting of a substrate and an electronic display device.

29. The method of claim 28, wherein the substrate comprises paper.

30. The method of claim 29, wherein the display comprises not more than two viewable pages of paper.

31. The method of claim 30, wherein the not more than two viewable pages of paper are disposed on opposing sides of a single sheet of paper.

32. The method of claim 29, wherein the display comprises a single viewable page of paper.

33. The method of claim 28, wherein the display comprises a computer monitor.

34. The method of claim 26, wherein the arm region includes information of a type selected from the group consisting of arm comparison information comparing each arm of the clinical trial; arm stratification information relating to stratification of patients treated in the clinical trial; and arm-specific information relating to at least one arm of the clinical trial.

35. The method of claim 34, comprising the further step of associating a visibly identifiable color with the arm region containing the arm-specific information, said visibly identifiable color being distinct from visibly identifiable colors associated with other arm-specific arm regions of the individual summary report.

36. The method of claim 26, comprising the further step of graphically displaying information in at least one of the spatially distinct, predefined regions.

37. The method of claim 26, wherein at least one spatially distinct arm region of the display further includes an administration region containing information relating to administration of treatment during the clinical trial.

38. A presentation system for succinctly presenting information contained in a clinical trial report, comprising:
a) a summary report, having information displayed thereon in a plurality of spatially distinct, predefined regions, each of the predefined regions having an information type associated therewith, the plurality of spatially distinct, predefined regions including:
i) a bibliographical region, including bibliographical information relating to the clinical trial report;
ii) a patient characteristic region, including patient characteristic information relating to patients treated in a clinic trial reported in the clinical trial report;
iii) an end point region, including end point information relating to at least one end point of the clinical trial;
iv) an arm region, including arm information relating to at least one arm of the clinical trial; and
v) a regimen region, including graphically presented regimen information relating to at least one arm of the clinical trial.

39. The system of claim 38, wherein each individual summary report is displayed on a display comprising a member selected from the group consisting of a substrate and an electronic display device.

40. The system of claim 39, wherein the substrate comprises paper.

41. The system of claim 40, wherein the display comprises not more than two viewable pages of paper.

42. The system of claim 41, wherein the not more than two viewable pages of paper are disposed on opposing sides of a single sheet of paper.

43. The system of claim 40, wherein the display comprises a single viewable page of paper.

44. The system of claim 39, wherein the display comprises a computer monitor.
